(19) United States
(12) Patent Application Publication
(10) Pub. No.: US 2008/0238649 A1
(43) Pub. Date: Oct. 2, 2008

(54) Warning Light

(75) Inventors: Jeffrey A. Arszman, COLUMBUS, OH (US); Thomas J. Barnett, POWELL, OH (US)

Correspondence Address: ELEY LAW FIRM CO., 7870 OLENTANGY RIVER RD, SUITE 311, COLUMBUS, OH, 43235, US

(73) Assignee: WELDON TECHNOLOGIES, INC., COLUMBUS, OH (US)

(21) Appl. No.: 12/058,723

(22) Filed: Mar. 30, 2008

Related U.S. Application Data
(63) Continuation-in-part of application No. 29/279,624, filed on May 4, 2007, now Pat. No. D571247.
(60) Provisional application No. 60/909,427, filed on Mar. 31, 2007.

(51) Int. Cl. B60Q 1/52

(52) U.S. Cl. 340/471

(57) ABSTRACT

A warning light. A generally planar lamp assembly has a plurality of lamps mounted to a front surface thereof and further includes a control portion having a wireless link. A programming device is configured to wirelessly transfer information to the wireless link for storage in the control portion, such that the control portion operates in accordance with the stored information to illuminate the lamps with illumination characteristics corresponding to the information.

This application claims priority to U.S. provisional patent application No. 60/909,427, filed Mar. 31, 2007, the contents of which are hereby incorporated by reference.

### FIELD

The present invention relates generally to warning lights, in particular to warning lights mounted to emergency vehicles.

### BACKGROUND

Warning lights are typically mounted to emergency vehicles to alert motorists in the vicinity of the emergency vehicles of their presence. When an emergency vehicle is in motion the warning lights provide an indication to motorists to allow the emergency vehicle to pass. Warning lights also draw motorists' attention to a stopped emergency vehicle, thereby reducing the risk of a collision. Warning lights may be configured with a plurality of light sources having one or more on-and-off or “flash” patterns intended to attract attention. Similarly, a group of warning lights may be configured to operate synchronously in a predetermined flash pattern. To accommodate this, warning lights often include a controller having a plurality of pre-programmed flash patterns.

A programming wire extending from the warning light is typically used to select a particular pre-programmed flash pattern. To program the warning light the programming wire is usually placed into electrical contact with a ground wire of the warning light a predetermined number of times, within a predetermined period of time after power is applied to the warning light. However, this programming operation requires that the warning light be dismounted from the vehicle with the electrical wiring of the warning light still connected to the vehicle, making programming in the field cumbersome. Alternatively, the programming wire may be wired to a dedicated programming switch installed in the vehicle. However, such wiring results in added labor, equipment expense and vehicle weight to facilitate a programming operation that is seldom changed once completed. There is a need for a way to easily program a warning light that does not require removal of the lamp assembly from the vehicle and does not require the expense of a wiring harness to facilitate the programming function.

### SUMMARY

A warning light is disclosed according to an embodiment of the present invention. The warning light includes a control portion having one or more pre-programmed flash patterns. A communications link facilitates programming of the warning light to display a select flash pattern through the use of a remotely-operated programming device, allowing the warning light to remain mounted to the vehicle during programming. The communications link also obviates the need to provide a separate wiring harness and switch within the emergency vehicle for programming the warning light. In some embodiments a user-designed flash pattern may be developed separately from the warning light and then programmed into the warning light by means of the programming device and the communications link.

An object of the present invention is a warning light. A generally planar lamp assembly has a plurality of lamps mounted to a front surface thereof and further includes a control portion having a wireless link. A programming device is configured to wirelessly transfer information to the wireless link for storage in the control portion, such that the control portion operates in accordance with the stored information to illuminate the lamps with illumination characteristics corresponding to the information.

Another object of the present invention is warning light having a generally planar lamp assembly with a plurality of lamps mounted to a front surface thereof. The warning light further includes a control portion having a wireless link. A reflector has a plurality of compartments with optic lenses, the optic lenses being proximate corresponding lamps and arranged to receive and direct light emitted by the lamps. A lens is facially adjacent a front surface of the reflector. A gasket having a front surface is facially adjacent to a rear surface of the lamp assembly. At least one thermally conductive electrical insulator is arranged intermediate the rear surface of the lamp assembly and the front surface of the gasket, the gasket further including a plurality of apertures generally corresponding to the lamps. A heat sink having a front surface is facially adjacent a rear surface of the gasket. A programming device is configured to wirelessly transfer information to the wireless link for storage in the control portion, such that the control portion operates in accordance with the stored information to illuminate the lamps with illumination characteristics corresponding to the information.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1A is a top view of a warning light according to an embodiment of the present invention;

FIG. 1B is a front elevational view of the warning light of FIG. 1A;

FIG. 1C is a side elevational view of the warning light of FIG. 1A;

FIG. 1D is a rear elevational view of the warning light of FIG. 1A;

FIG. 2 is an exploded view showing the general arrangement of a warning light according to an embodiment of the present invention;

FIG. 3A shows a cover lens of a warning light with indicia according to an embodiment of the present invention;

FIG. 3B shows a cover lens of a warning light with indicia according to another embodiment of the present invention;

FIG. 4 is a schematic block diagram of a warning light control portion according to an embodiment of the present invention;

FIG. 5 shows the general arrangement of a system for programming a warning light according to an embodiment of the present invention;

FIG. 6 shows the general arrangement of a programming device according to an embodiment of the present invention;

FIG. 7 is a schematic block diagram of the programming device of FIG. 6;

FIG. 8 shows the programming device of FIG. 6 being used to program a warning light according to an embodiment of the present invention; and

FIG. 9 is a schematic block diagram showing a system comprising a plurality of warning lights and associated wiring according to an embodiment of the present invention.

### DETAILED DESCRIPTION

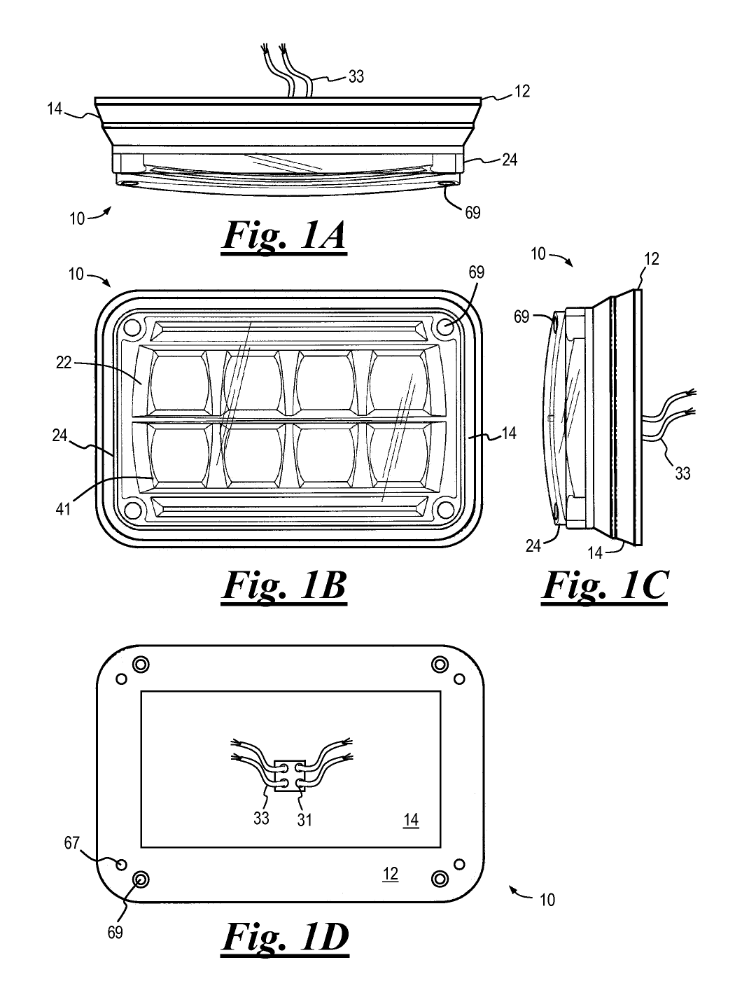

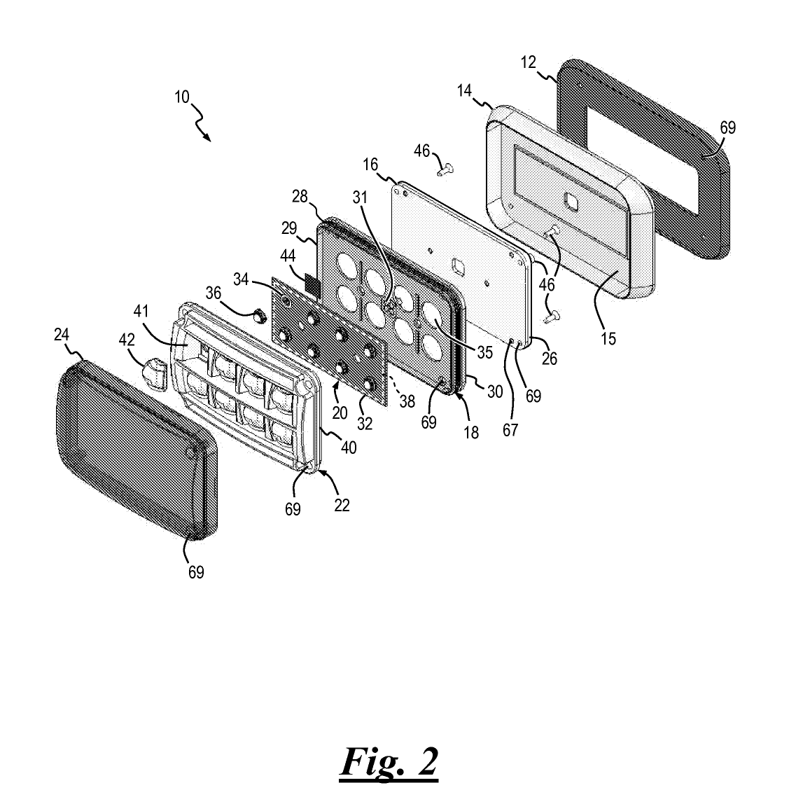

The general arrangement of a warning light 10 is shown in FIGS. 1A, 1B, 1C, 1D and 2 according to an embodiment of the present invention. Warning light 10 may include a mounting pad 12, a bezel 14, a heat sink 16, a gasket 18, a lamp assembly 20, a reflector 22 and a cover lens 24.

Optional mounting pad 12 provides a generally watertight seal between an assembled warning light 10 and a surface such as a body of a vehicle (not shown) upon which the warning light may be mounted, thereby preventing moisture ingress into the vehicle body through apertures provided therein for mounting the warning light and routing associated electrical wiring. Mounting pad 12 also adds to the aesthetics of warning light 10 by providing a finished appearance at the interface between the warning light and the vehicle body while at least partially closing off the vehicle body apertures. Mounting pad 12 may be made from any material suitable for use with other components of warning light 10 and the expected environment. Example materials include, but are not limited to, natural or synthetic rubber, thermoplastic elastomers and silicone. Mounting pad 12 may be formed in any conventional manner, such as molding and manual- or die-cutting.

Bezel 14 may optionally be provided to add to the aesthetics of warning light 10. As shown in FIG. 2, bezel 14 is preferably sized and shaped such that the assembled warning light fits into a cavity 15 of the bezel. If made from a thermally conductive material, bezel 14 may also aid to dissipate heat generated by warning light 10. In such embodiments a thermally conductive pad 26 may be placed intermediate a front surface of bezel 14 and a rear surface of heat sink 16 to provide a thermal path with relatively low thermal resistance. Alternatively, bezel 14 may be placed into direct contact with heat sink 16. In yet other embodiments an air gap may be provided between bezel 14 and heat sink 16 to allow heat energy to radiate from the heat sink to the bezel. Bezel 14 may be made from any material suitable for use with other components of warning light 10 and the expected environment. Example materials include, without limitation, metal, plastic and composites. Bezel 14 may be formed in any conventional manner including, but not limited to, molding, casting, machining and stamping. Bezel 14 may be finished with a reflective coating, colored paint, colorants integral to the material, or left unfinished.

Heat sink 16 provides a thermal path for dissipating heat generated by lamp assembly 20. Heat sink 16 is generally planar, but may include features such as fins, ridges and apertures to aid in heat dissipation. Heat sink 16 may be made from any suitable material that is compatible with other components of warning light 10 and the expected environment. Example materials include, but are not limited to, metal, thermally conductive plastic and ceramic. Heat sink 16 may be formed in any conventional manner including, but not limited to, molding, casting, machining and stamping, and combinations thereof. Furthermore, heat sink 16 may be finished by painting, colorants integral to the material, plating, or may be left unfinished.

Gasket 18 provides a moisture-resistant barrier to protect the assembled warning light 10 from moisture ingress. To that end, gasket 18 may include one or more generally thin ribs 28 that contact the interior surfaces of cover lens 24 in an assembled condition to provide a moisture-resistant seal. Gasket 18 also includes a lip 29 that is exposed around the perimeter of warning light 10 when cover lens 24 is assembled to the warning light. Lip 29 may fit around the periphery of heat sink 16 to provide a moisture seal between lens cover 24 and the vehicle-side surface of bezel 14. Gasket 18 may further include wire exit seals 31 formed therein that closely conform to the physical size of electrical wires 33 extending therethrough, to provide a moisture-resistant barrier to deter moisture ingress into warning light 10 around the electrical wires exiting warning light 10. Gasket 18 may be compressible to provide cushioning and to compensate for any tolerance stack-up between various components of warning light 10, thus deterring movement of the various components in the warning light assembly when exposed to shock and/or vibration. Gasket 18 may be made from any material suitable for use with other components of warning light 10 and the expected environment including, without limitation, natural or synthetic rubber, thermoplastic elastomers and silicone. Gasket 18 may be formed in any conventional manner, such as molding, and manual- or die-cutting.

Lamp assembly 20 is generally planar and includes a printed wiring board 32 having a plurality of lamp receptacles 34 mounted to receive lamps proximate a front surface of the printed wiring board. A plurality of lamps 36, such as light emitting diodes, may be mechanically and electrically coupled to corresponding receptacles 34. Lamp assembly 20 also includes a control portion 38, detailed further below.

A thermally conductive pad 30 may optionally be placed between heat sink 16 and gasket 18 to provide a thermal path for dissipating heat generated by lamps 36. In some embodiments of the present invention pad 30 may be sufficiently resilient to extend through apertures 35 of gasket 18 and into contact with receptacles 34, thereby providing a thermal path for conducting heat generated by lamps 36 away from the receptacles and toward heat sink 16.

Lamps 36 may be any type of light emitting source now known or later developed, such as incandescent lamps. In one embodiment of the present invention lamps 36 may be V-LED™ light emitting diodes (“LEDs”) available from Weldon Technologies, Inc. of Columbus, Ohio. The V-LED™ LED may comprise a single LED die or may comprise a plurality of LED dice. The LED die/dice may be either one color or may comprise a combination of colors to provide a distinctive visual emission signal. In some embodiments warning light 10 may be upgraded or customized by replacing lamps 36 with other lamps having a higher light output level and/or different colors. Color mixing/changing is also achievable when using multiple-die V-LED™ LEDs. Exemplary lamps 36 are detailed in U.S. Pat. Nos. 7,138,667, 6,903,380 and 6,541,800 to Barnett, et al. the entire contents of each patent being incorporated herein by reference thereto.

In various embodiments of the present invention each lamp 36 mounted to printed wiring board 32 may be illuminated individually or in determinable groups or modules, depending upon the layout of the printed wiring board. In some embodiments lamps 36 are individually detachable from printed wiring board 32 via receptacles 34 to facilitate servicing of warning light 10 in the field, should a lamp 36 require replacement. Alternatively, receptacles 34 may be omitted and lamps 36 mounted directly to printed wiring board 32, such as with adhesives and/or soldering.

Reflector 22 comprises a frame 40 having a plurality of compartments 41 with a plurality of corresponding optic lenses 42. Frame 40 is preferably generally finished with a reflective coating to guide and direct light emitted by warning light 10 and to provide a desirable aesthetic appearance. Frame 40 may be made from any material compatible with other components of warning light 10 and the expected environment including, without limitation, plastic, ceramic and metal. Frame 40 may be formed in any conventional manner including, but not limited to, molding, casting, machining and stamping. Furthermore, frame 40 may be finished by painting, colorants integral to the material, plating, or may be left unfinished.

Optic lenses 42 are situated in compartments 41 and provide beam shaping for light emitted by lamps 36. The beam shaping may be configured to direct light in a predetermined horizontal and/or vertical axis with respect to warning light 10. In various embodiments of the present invention optic lenses 42 may be colorless or may be provided in any desired color, such as the same general color of light emitted by lamps 36. Alternatively, optic lenses 42 may be configured in any conventional manner, such as with paint, ink, dye and pigment, to cause color shifting of light emitted by lamps 36 as the light passes therethrough. Optic lenses 42 may also be omitted in some embodiments, the beam pattern being shaped by at least one of frame 40, compartments 41 and cover lens 24. Optic lenses 42 may be made from any material compatible with other components of warning light 10 and the expected environment including, without limitation, transparent or translucent glass or plastic. Optic lenses 42 may be formed in any conventional manner including, without limitation, molding and machining.

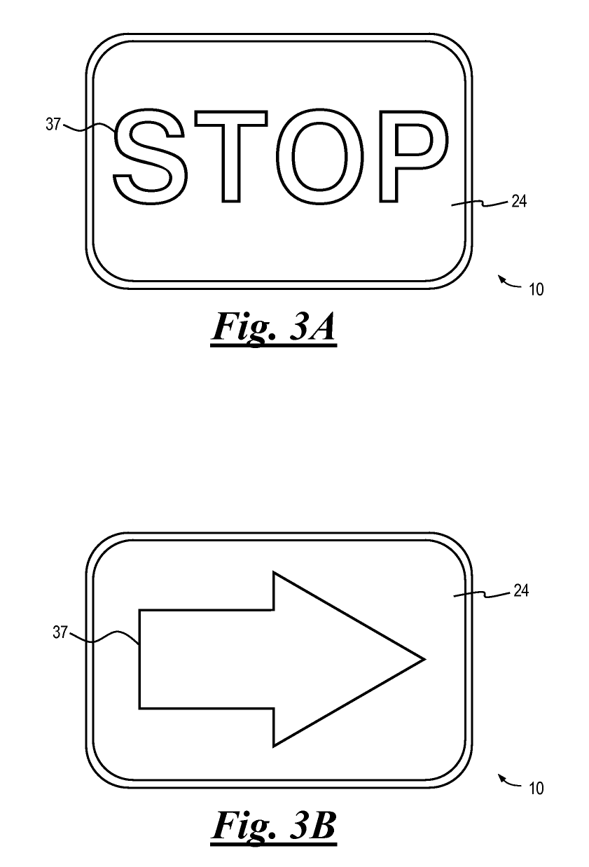

Cover lens 24 protects the interior portions of warning light 10 from the elements and from damage due to incidental contact therewith. In various embodiments the interior and/or exterior surfaces of cover lens 24 may be generally planar, or may additionally include one or more optical features such as Fresnel and prism optical structures, diffusers, reflectors, refractors, optical patterns and geometries to direct light emitted by lamps 36 into a predetermined beam pattern. Cover lens 24 may be provided in a predetermined color, or may be colorless. In addition, cover lens 24 may be generally transparent or may be translucent. Cover lens 24 may further include features such as apertures and molded-in clips and tabs that provide means for temporary or permanent attachment of the lens to warning light 10. Cover lens 24 may also be configured with symbolic or textual indicia, such as “STOP” legends and turn arrows, as generally illustrated by FIGS. 3A and 3B. Cover lens 24 may be made from any material suitable for use with other components of warning light 10 and the expected environment. Example materials include, without limitation, glass and plastic. Cover lens 24 may be formed in any conventional manner including, but not limited to, molding, casting and machining.

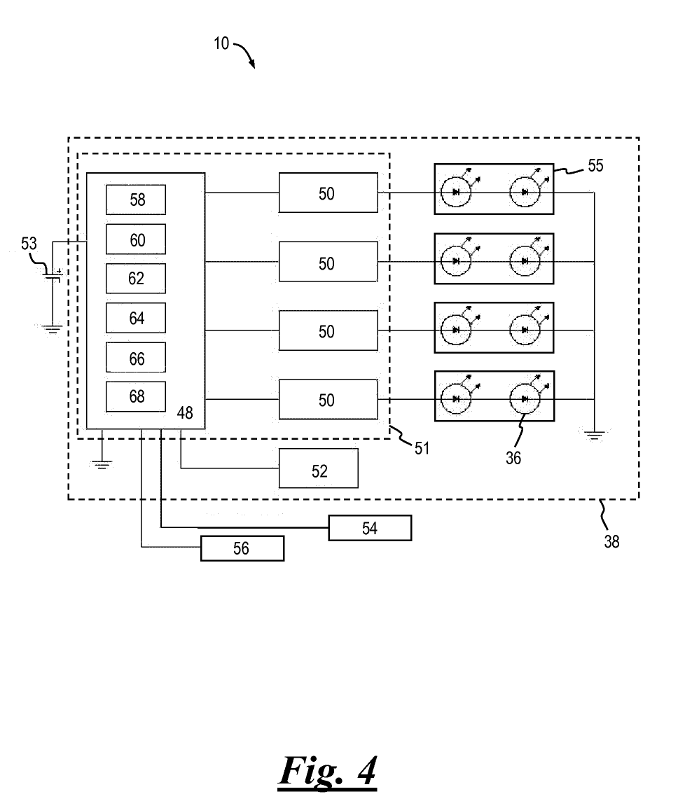

Details of control portion 38, which is made part of printed wiring board 32, are shown in FIG. 4 according to an embodiment of the present invention. Control portion 38 includes a controller 48, a plurality of LED drivers 50 and a wireless link 52. Power to controller 48 and, in turn, warning light 10, is supplied by an external power supply 53, such as an electrical system of an emergency vehicle.

Controller 48 receives electrical signals from any or all of wireless link 52, a mode control input 54 and a sync line 56 and controls the operation of warning light 10 in a predetermined manner. Example control tasks for controller 48 may include, without limitation, providing determinable output command signals to one or more LED drivers 50 which in turn selectably illuminate lamps 36 associated therewith. Controller 48 may also detect fault conditions present in components of warning light 10 and/or interconnections thereof. Non-limiting example fault conditions may include internal faults within controller 48, open or shorted electrical connections in the warning light assembly, low input power supply 53 voltage, and fault conditions present in any or all of LED drivers 50 and lamps 36. Controller 48 may be configured using conventional analog or digital electronic circuitry or a combination thereof, and may additionally include conventional memory devices such as magnetic, electronic and optical memory storage devices containing a predetermined set of instructions, such as a computer program. In the example embodiment shown in FIG. 4 controller 48 may be a conventional integrated-circuit microprocessor or a microcontroller with an internal random access memory (RAM) 58, a program memory 60 such as a conventional “FLASH” memory, an interrupt controller 62, a timer 64, a communications port 66 and an oscillator 68.

LED drivers 50 receive command signals from controller 48 and cause lamps 36 to illuminate in a manner corresponding to the command. LED drivers 50 may be any conventional driver compatible with lamps 36 such as, for example, LED drivers that control the voltage and/or current supplied to lamps 36 in a predetermined manner to illuminate the lamps and control their brightness and/or color. Example types of drivers include, but are not limited to, analog voltage and current drive controlled drivers, digital-controlled drivers, duty-cycle controlled drivers, and pulse and pulse-width modulation controlled drivers. LED drivers 50 may drive a single die within corresponding lamps 36, or may separately drive a plurality of dice in the lamps to produce a desired color and/or light output brightness. In some embodiments controller 48 may include one or more LED drivers 50 integrated therewith, as generally denoted by broken line 51 in FIG. 4.

In some embodiments warning light 10 may include a plurality of independently-operated lamps 36, the illumination of each lamp being controlled by a separate LED driver 50. Alternatively, warning light 10 may comprise a plurality of lamps 36 organized into groups 55, the illumination of each group being controlled by a separate LED driver 50. In still other embodiments of the present invention a single, integrated LED driver 50 having plural drive outputs coupled to corresponding lamps 36 may be utilized. Control portion 38 is configured such that controller 48 may actuate one or more of LED drivers 50 independent of the other LED drivers. The flash patterns associated with each LED driver 50 may differ; however, all output channels preferably share the same synchronization, phase, and mode state, as further detailed below.

Wireless link 52 comprises a conventional receiver configured to receive a modulated signal from a signal source external to warning light 10. Wireless link 52 may be configured to receive any conventional type of signal such as, without limitation, radio frequency (RF), infrared (IR) and ultrasonic signals having analog and/or digital modulation. The modulation information is decoded by wireless link 52 and/or controller 48. The decoded information may include a set of predetermined instructions, such as a computer program, that define the operation of controller 48. The instructions may be stored, for example, in program memory 60 of controller 48.

With reference again to FIG. 2, warning light 10 is assembled by attaching optic lenses 42 to corresponding reflector 22 compartments 41 in any conventional manner. In some embodiments optic lenses 42 may include snap tabs configured to engage compartments 41 within frame 40. Alternatively, optic lenses 42 may be attached to frame 40 with adhesive, retaining clips, fasteners or a combination thereof.

Lamps 36 are mounted to corresponding receptacles 34 of lamp assembly 20. Alternatively, lamps 36 may be mounted directly to printed wiring board 32 with adhesive and/or solder. If needed, one or more insulators 44 are placed intermediate a rear surface of lamp assembly 20 and a front surface of gasket 18 to provide electrical insulation between the lamp assembly and heat sink 16. Insulator 44 is a generally thermally conductive material and is preferably a generally soft, pliable material in order to conform to any surface irregularities between printed wiring board 32 and heat sink 16. Suitable materials for insulator 44 include silicone rubber and fiberglass composites, as well as thermal materials such as SIL-PAD and GAP-PAD, both offered by the Bergquist Co. of Chanhassen, Minn. Insulator 44 may be omitted in embodiments where either the lamp assembly 20 or heat sink 16 are not electrically conductive.

Lamp assembly 20 is placed proximate a corresponding rear surface of reflector 22 such that lamps 36 are proximate and generally aligned with corresponding optic lenses 42. A front surface of gasket 18 is placed proximate a rear surface of lamp assembly 20, capturing printed wiring board 32 therebetween and routing wiring 33 (FIGS. 1A, 1C, 1D) of the lamp assembly through corresponding wire seals 31 in the gasket. A front surface of heat sink 16 is placed proximate a rear surface of gasket 18. Fasteners 46, such as screws, are placed through aligned assembly apertures 67 of heat sink 16 and gasket 18, engaging corresponding receptacles in reflector 22 to secure the assembly. Cover lens 24 is then fitted over reflector 22, facially adjacent a front surface of the reflector. The assembly is then placed into a cavity 15 formed in a front surface of bezel 14, with a rear surface of heat sink 16 facially adjacent to the cavity. A front side of mounting pad 12 is placed facially adjacent to a rear surface of bezel 14. The assembled warning light 10 may be mounted by installing fasteners such as screws (not shown) through aligned mounting apertures 69 of lens 24, reflector 22, gasket 18, heat sink 16, bezel 14 and mounting pad 12, the fasteners engaging the surface to which the warning light is to be mounted.

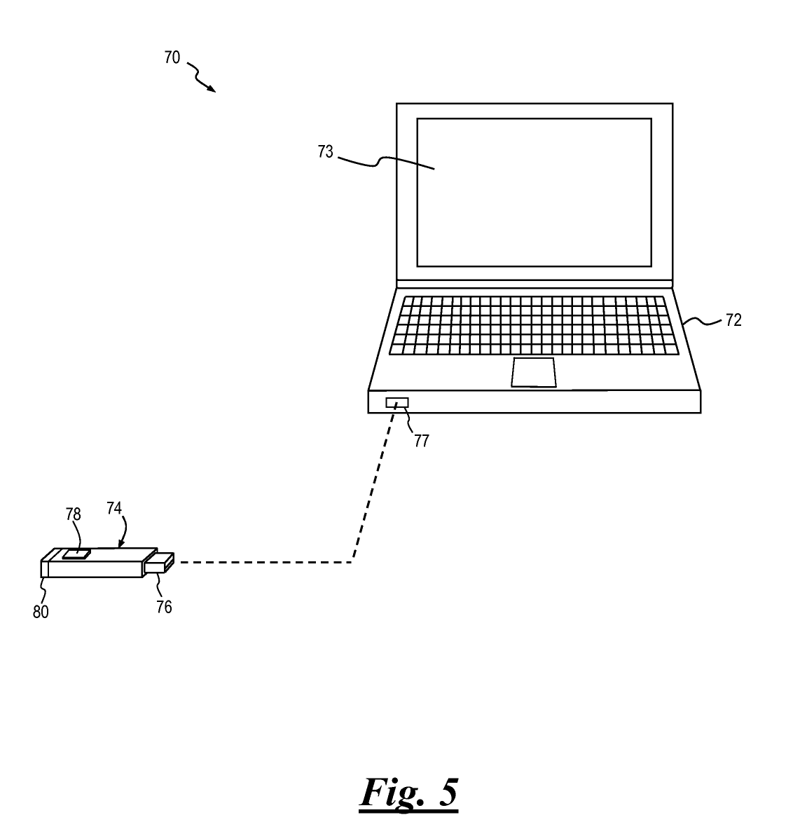

FIG. 5 shows the general arrangement of a programming system 70 for programming a warning light 10 according to an embodiment of the present invention. Programming system 70 comprises a computer 72 operating a predetermined set of instructions, such as a lamp configurator computer program, and a programming device 74 adapted to detachably mechanically and electrically interface with the computer.

The configurator computer program used in conjunction with computer 72 may include a feature whereby the flash pattern of a set of configuration instructions is visually presented on a monitor screen 73 of computer 72. This feature allows a user to enter, view and edit a representative simulation of the lamp illumination characteristics (i.e., the “flash pattern”) for each of lamps 36 (FIG. 4) or light modules 55 comprising a single lamp 36 and/or groups of lamps 36 (hereafter “modules”). After preparing the configuration instructions a user may use a computer simulation or model portion of the configurator program of computer 72 to preview a flash pattern for warning light 10 corresponding to the configuration instructions. The simulation preferably is shown on display screen 73 of computer 72. The configurator computer program may also provide the user with information relating to the compliance of the flash pattern with one or more predetermined standards and/or government regulations.

Each of lamps 36 (or modules 55) of warning light 10 may have a flash pattern that is represented as the total of a duration of time and a sequential series of segments, each segment having starting point in time, initial intensity and ending intensity. The total duration for a segment is determined by taking the start time of the following segment and subtracting the current segment's start time. Knowing this information allows one to describe, graphically, a line that represents intensity over time. Furthermore a user may, using the configurator computer program of programming system 70, define directives such as simple preprogrammed routines or complex transforms of the line represented as a set of processing operations.

The configurator computer program of programming system 70 may be adapted to graphically represent the flash pattern of each lamp 36 (or module 55) by graphical means, such as lines projected over a linear timeline. Each segment's characteristics, such as starting and stopping intensity, may be adjusted using a conventional graphical user interface. Editing of the functional characteristics of warning light 10 may be further simplified by allowing the user to group two modules together and assign them to a single pattern. Warning lights 10 grouped in such a way can also be indicated to be out of phase by 180 degrees to the other member, such that it is executing the middle of the pattern as the other light executes the start of the pattern.

An animated illustration may be viewed on display 73 of computer 72 to provide a user with a visual representation of the pattern for a select warning light 10. During playback on computer 72 an indicator will be overlaid on top of the flash pattern in the editor and kept in sync with the animated simulation representing the operating characteristics of warning light 10. The configurator computer program may provide controls to allow a user to start, stop, fast forward, rewind and change the speed of playback.

By examining the duration and intensities achieved by all modules in a warning light 10 over the entire flash pattern, as well as knowing the photometric characteristics of the lamp, it is possible to provide feedback to the user with regard to regulatory compliance. The feedback may be in the form of, but not limited to, recommendations of the number of lamps 36 needed to satisfy a regulation, quantitative measures such as candela power per second (cd/sec), cd/sec per minute, and so on.

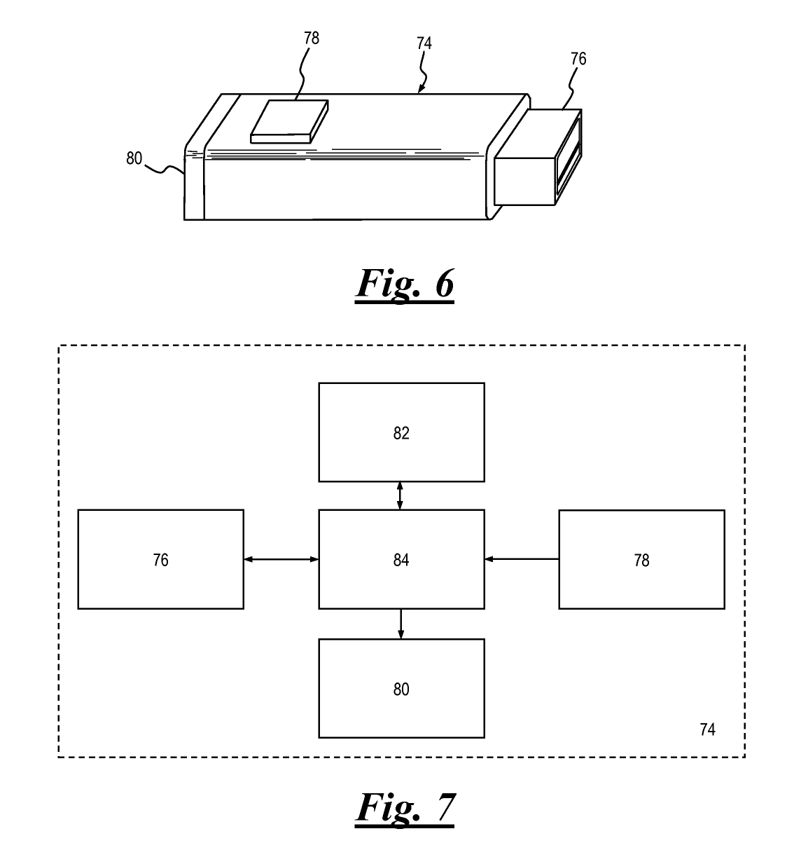

FIGS. 6 and 7 show the general arrangement of programming device 74, which includes an electrical interface connector 76, an actuator 78 and a transmitter portion 80. Programming device 74 further includes a memory portion 82 such as a conventional “FLASH” memory and a control 84, such as a microprocessor or microcontroller. Memory portion 82 may be similar in structure and function to memory 60 of controller 48. Likewise, control 84 may be similar in structure and function to controller 48. Accordingly, memory portion 82 and control 84 will not be elaborated further here.

Although programming system 70 is generally depicted in FIGS. 5-7 as comprising separable, standalone devices 72, 74, it should be noted that the programming system may be integrated into a single device including, but not limited to, a laptop computer, handheld computer, personal digital assistant (“PDA”) and mobile telephone comprising the functional aspects and features of computer 72 and programming device 74. Similarly, programming system 70 may comprise such an integrated device that is further configured to optionally detachably mechanically and electrically interface with computer 72, wherein portions or all of the functions of the programming system reside in either or both the integrated device and the computer.

Using programming system 70 (FIG. 5), warning light 10 may be configured such that the lamps 36 therein have a particular phase setting relative to the flash pattern definition for a group of warning lights. For example, when expressed in degrees, a warning light 10 with a phase offset of zero degrees may be considered a reference point. Accordingly, a warning light 10 with a phase offset of 180 degrees will be halfway through its flash pattern period at the moment the reference warning light is executing the beginning of its pattern. All lamps 36 of a group of warning lights 10 may share the same phase setting, even though their flash patterns may differ. The phase information may be stored separately from the flash pattern definition portion of the instructions stored in program memory 60, allowing the phase information to be altered without altering the flash pattern itself.

Microcontroller 48 and LED drivers 50 (FIG. 4) may be configured, with system 70, to toggle each lamp 36 or a group of lamps (hereafter generally, “channel”) of the warning light on and off as a function of time, as well as dim the lamps to various degrees when illuminated. In order to accomplish these tasks efficiently, control portion 38 may be configured to generate two separate signals internally for each output channel: a pulse-width modulated (PWM) signal, and an on/off signal. The PWM signal is generated continuously, without regard to whether the channel is intended to be active at a given moment. This signal is then combined with a separate on/off signal. If the on/off signal is on, the PWM signal is allowed to drive the output channel. If the signal is off, the PWM signal is squelched and the output channel is not driven. This signal separation allows for more efficient processing, as two parallel processes can be run to individually handle the task of processing an on/off signal or a generating a PWM pulse train. It also allows for more efficient storage of flash patterns in non-volatile memory.

In order to be processed by the control portion 38 of warning light 10, a flash pattern may be “discretized,” that is, divided into a series of generally equally-sized segments of time. An output channel of a flash pattern has only one PWM value associated with each of these time segments. In this way, the time segments act as a basic building block from which all flash patterns can be constructed. This greatly reduces the complexity of the flash pattern configuration instructions stored in program memory 60. Instead of executing a different set of instructions for each flash pattern, the controller 48 may execute merely one generic loop of configuration instructions, which is run on an interval of time equal to the length of the basic building block time segment. The loop's only task is to output each channel's PWM value corresponding to the current time segment block, then delay until the next block is to be processed.

This discretization also enables flash patterns to consume less space in the memory 60 of warning light 10. By nature, most desired flash patterns for warning light 10 are periodic (for example, a simple on/off pattern might flash at 75 flashes per minute), so one period contains sufficient information to describe the pattern. The flash pattern is “sampled” over this period at a rate equal to the period divided by the building block segment length. Therefore, there is a finite maximum number of data points required to represent any given pattern. In conjunction with the fact that on/off and PWM values are separated, as discussed previously, these sampled data points may be further reduced by using a number of different compression methods. For example, the compression efficiency may be increased by restricting all of a lamp's output channel flash patterns to have a common period.

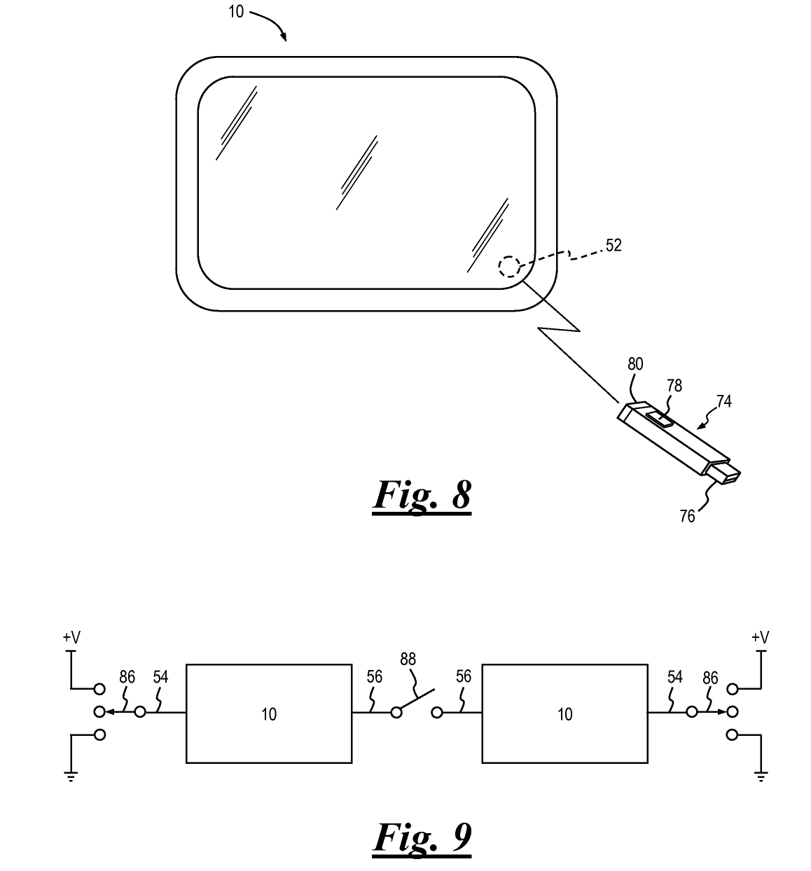

With reference to FIGS. 5, 6, 7 and 8 together, in use computer 72, in conjunction with a configurator computer software program installed therein, is utilized by a user to define the operational characteristics of a warning light 10. Such operational characteristics may include, without limitation, lamps 36 brightness, on-time, off-time, and on-off patterns of individual lamps and groups of lamps, phase of the flash patterns, configurations for mode control 54, security settings, and controller 48 firmware, as well as synchronization patterns between a plurality of warning lights 10. Connector 76 of programming device 74 is coupled to a corresponding interface connector 77 of computer 72 which may comprise, without limitation, serial, parallel, USB, fire-wire or any other suitable standard or proprietary mechanical/electrical interface and data-transfer protocol arrangement. The defined operational characteristics are transferred from computer 72 to memory portion 82 of programming device 74 in the form of a set of configuration instructions (e.g., a computer program). The programming device 74 is then detached from computer 72 and carried to a warning light 10 to be programmed. Power supply 53 is coupled to warning light 10, causing it to begin operating. Programming device 74 is then placed proximate wireless link 52 of warning light 10 and actuator 78 of the programming device is then actuated. Control 84 of programming device 74 acts in cooperation with control portion 38 to transfer the configuration instructions in memory portion 82 of the programming device to program memory 60 of warning light 10 via transmitter 80 of the programming device and wireless link 52 of control portion 38. Successful reception of valid information via the wireless medium may be indicated by a short, recognizable sequence of flashes on warning light 10. Warning light 10, when supplied with electrical power, thereafter operates in accordance with the most recent configuration instructions stored in program memory 60.

Once a warning light 10 is configured, the end user may prevent the warning light from being inadvertently reprogrammed. To accomplish this, control portion 38 of warning light 10 may be provided with a selectable secure mode, controlled via programming device 74 and wireless link 52, to deter inadvertent changes to the flash pattern configuration instructions. Once activated, warning light 10 will no longer accept commands or data received by means of programming device 74 and wireless link 52, with the exception of a predetermined command to exit secure mode. This command, however, may be configured to be accepted by controller 48 only if certain hardware-based criteria are met. For example, warning light 10 may be configured to accept the secure-disable command only if sync line 56 is held at a predetermined electrical level, such as a minimum/maximum voltage or a digital logic level, for a specified length of time.

With reference to FIGS. 4 and 9, controller 48 may be configured to store more than one predetermined flash pattern. While operating, any of these predetermined patterns may be displayed by warning light 10, based upon the state of mode control input line 54 (FIG. 4). Mode control input line 54 may be utilized to provide at least one selectable operating mode of a warning light 10. The selectable operating modes, which may be defined in the aforementioned configuration instructions, may include predetermined brightness, on-time, off-time, and on-off patterns of individual lamps 36 and groups of lamps, as well as synchronization patterns between a plurality of warning lights 10. In some embodiments of the present invention mode control input 54 may be wired to a tri-state mode control switch 86 to facilitate selection of a desired mode, as generally shown in FIG. 9. In this embodiment a first warning light 10 mode is selected when switch 86 couples mode control input 54 to a predetermined voltage source (“+V”). A second warning light 10 operating mode is selected when mode control input 54 is “floating,” that is, connected neither to a voltage source nor an electrical ground. A third warning light 10 operating mode is selected when control switch 86 couples mode control input 54 to an electrical ground. The predetermined signals provided to mode control line 54 may be any conventional combination of analog and/or digital signals.

In some applications it may be desirable for a group of warning lights 10 operating together in a system to flash in a synchronous fashion. With continued reference to FIGS. 4 and 9, sync line 56 is utilized to synchronize their operation in a predetermined manner. When sync control switch 88 is open, the warning lights 10 are unsynchronized and execute a predetermined flash pattern in accordance with their own individual timing. When sync control switch 88 is closed, the warning lights 10 are linked together via the sync lines 56 and execute the flash pattern in synchronism. Alternatively, the sync lines 56 of the warning lights 10 may be non-selectably wired together, causing the warning lamps 10 to always flash in a synchronous pattern when operating. The predetermined signals provided to sync line 56 may be any conventional combination of analog and/or digital signals. Further details regarding timing and synchronous operation of a group of warning lights 10 are provided below.

In operation of the synchronous mode, sync line 56 of each participating warning light 10 of a system is coupled together in the manner described above. Sync line 56 may be configured with at least two operating levels or states, termed “active” and “inactive.” Controller 48 of each warning light 10 on the system may read the state of sync line 56 at any time, while at the same time optionally activating it. If sync line 56 is activated by at least one warning light 10, then the line is read as “active” by all warning lights 10 coupled thereto. If no warning light 10 is activating sync line 56, it is considered to be in an “inactive” state. In this way, the sync line 56 may be viewed as a “logical OR” signal wherein each warning light 10 of the system may control the active/inactive state of the sync line to maintain synchronization.

During normal operation, each warning light 10 expects to sense the sync line 56 transition to the active state once every sync period. This sync period will be specified as part of the configuration instructions of the warning light 10 and will be known by each of the programmed warning lights. After the sync line 56 is activated, it is then expected to deactivate within a relatively short period of time, defining a sync pulse width.

All timing related to performing the flash patterns on each warning light 10 will be established based upon the measured time between sync pulses. No matter how much time actually elapses between sync pulses (within reasonable limits), each warning light 10 will accept the measured duration of time as one sync period, and base all of its flash pattern timing on that calculation accordingly. For example, assume the sync period is four seconds and a warning light 10 is programmed to flash four times per sync period. Accordingly, the warning light 10 will flash once per second. If the sync pulse is received by that warning light 10 on 3 second intervals instead of the expected 4 second intervals, then the warning light 10's internal timing will be adjusted such that the warning light still flashes four times per sync period, or equivalently, periodically.

It should be noted that there is no dedicated “master” or “slave” warning light 10 in a group of warning lights to control a commonly-connected sync line 56. Instead, each independent warning light 10 is provided with an internal sync period timer. The initial period value for this timer is retained by each warning light 10 as a point of reference and may be calibrated when a warning light 10 is manufactured. If this timer expires before a sync pulse is detected, the warning light 10 will assert the sync pulse on the sync line 56. If a sync pulse is detected before the timer expires, then the timer is adjusted to account for this discrepancy. In this way, any warning light 10 in a system can act as the “sync master” at any given time.

During each sync period, each warning light 10 must rely on its own internal sync timer as the time base for its flashing tasks. If a sync pulse is sensed before the sync timer expires, the remaining portion of the flash pattern of warning light 10 will still be unprocessed. In order to prevent truncating the flash pattern of warning light 10 in this instance, the warning light 10 will instead make a slight adjustment to decrease its internal sync timer period and continue its flash processing normally. The degree of this adjustment may vary dynamically based on the amount of adjustment needed, much like a proportional-integral-derivative (“PID”) control algorithm, so as to eventually reach the desired sync period. In this way, the warning light 10 will “catch up” to the sync line 56 over a short period of time which will result in much smoother execution of flash patterns in terms of the aesthetics of a group of warning lights.

A system comprising a group of warning lights 10 configured in this manner will tend to operate based on the sync period of the warning light with the shortest initial sync timer period. Assuming that the internal timing of a given set of warning lights 10 will vary within a range of tolerance, one can expect the fastest warning light to be faster than the actual desired sync period. In addition, as the slower warning lights 10 adjust, they are likely to overshoot their adjustments at some point, thus decreasing the system sync period even further. To guard against this behavior, the warning light 10 whose sync timer expires (thus making it the “master” for the next sync period) makes a slight adjustment to its internal sync timer in the opposite direction. In other words, the warning light 10 that activates the sync line 56 will gradually lengthen its sync period in order to protect against excessively short sync periods. Again, this adjustment can be dynamically calculated to provide intelligent fine-tuning and is limited within a certain percentage of the initial reference value of warning light 10 to prevent eventual excessively long sync periods.

In a working system, each warning light 10 is designed to make fine-tuning adjustments to its own sync timer period within a small degree of variation relative to its initial reference value. Slow warning lights 10 make adjustments to more closely match faster warning lights, while faster warning lights gradually adjust to meet the speed of slower warning lights. Therefore, the entire system tends to operate based on a sync period that is an average of the initial reference values of each of the warning lights 10 present in the system. If any warning light 10 drops out of a system due to an unexpected failure, the remainder of the system continues to function correctly. Further, a single warning light 10 operates correctly at its initial reference rate—without the need for any additional software considerations. In this way, a sync signal is not required for correct operation in a standalone configuration.

While this invention has been shown and described with respect to detailed embodiments thereof, it will be understood by those skilled in the art that changes in form and detail thereof may be made without departing from the scope of the claims of the invention.

What is claimed is:

1. A warning light, comprising:
a generally planar lamp assembly having a plurality of lamps mounted to a front surface thereof and further including a control portion having a wireless link; and
a programming device configured to wirelessly transfer information to the wireless link for storage in the control portion,
wherein the control portion operates in accordance with the stored information to illuminate the lamps with illumination characteristics corresponding to the information.

2. The warning light of claim 1, further comprising a reflector having a plurality of compartments, the compartments being proximate corresponding lamps and arranged to receive and direct light emitted by the lamps.

3. The warning light of claim 2, wherein the compartments further comprise optic lenses.

4. The warning light of claim 1, further comprising a cover lens facially adjacent the front surface of the lamp assembly.

5. The warning light of claim 4 wherein the cover lens further includes predetermined indicia.

6. The warning light of claim 1, further comprising a gasket having a front surface facially adjacent to a rear surface of the lamp assembly.

7. The warning light of claim 6 wherein the gasket further includes a plurality of ribs and wire exit seals formed therein.

8. The warning light of claim 6, further comprising at least one thermally conductive electrical insulator arranged intermediate the rear surface of the lamp assembly and the front surface of the gasket, the gasket further including a plurality of apertures generally corresponding to the lamps.

9. The warning light of claim 6, further comprising a heat sink having a front surface facially adjacent a rear surface of the gasket.

10. The warning light of claim 9, further comprising a bezel having a front surface facially adjacent to a rear surface of the heat sink.

11. The warning light of claim 10, further comprising a thermally conductive pad intermediate the rear surface of the heat sink and the front surface of the bezel.

12. The warning light of claim 10, further comprising a mounting pad having a front surface facially adjacent a rear surface of the bezel.

13. The warning light of claim 1 wherein the lamp assembly further includes a plurality of lamp receptacles configured to detachably receive the lamps.

14. The warning light of claim 1 wherein the lamps are light emitting diodes.

15. The warning light of claim 1 wherein the control portion includes a mode control input configurable in conjunction with the control portion to select one of a plurality of lamp illumination characteristics.

16. The warning light of claim 1 wherein the control portion further includes a sync input configurable to cause the warning light to operate in a synchronous manner with at least one additional warning light.

17. The warning light of claim 1 wherein the control portion is configured to be selectably secured to deter transfer of information from the programming device to the control portion.

18. A warning light, comprising:
a generally planar lamp assembly having a plurality of lamps mounted to a front surface thereof and further including a control portion having a wireless link;
a reflector having a plurality of compartments with optic lenses, the optic lenses being proximate corresponding lamps and arranged to receive and direct light emitted by the lamps;
a lens facially adjacent a front surface of the reflector;
a gasket having a front surface facially adjacent to a rear surface of the lamp assembly;
at least one thermally conductive electrical insulator arranged intermediate the rear surface of the lamp assembly and the front surface of the gasket, the gasket further including a plurality of apertures generally corresponding to the lamps;
a heat sink having a front surface facially adjacent a rear surface of the gasket; and
a programming device configured to wirelessly transfer information to the wireless link for storage in the control portion,
wherein the control portion operates in accordance with the stored information to illuminate the lamps with illumination characteristics corresponding to the information.

19. A method for providing illumination, comprising the steps of:
providing a plurality of lamps and a control portion having a wireless link;
locating a reflector having compartments such that the compartments are proximate corresponding lamps and are arranged to receive and direct light emitted by the lamps; and
transferring, by wireless means, information to the wireless link for storage in the control portion such that the control portion operates in accordance with the stored information to illuminate the lamps with illumination characteristics corresponding to the information.

20. The method of claim 19, further including the step of providing the control portion with a mode control input that is configurable in conjunction with the control portion to select one of a plurality of lamp illumination characteristics.

21. The method of claim 19, further including the step of providing the control portion with a sync input that is configurable to cause the warning light to operate in a synchronous manner with at least one additional warning light.
